(19) United States
(12) Patent Application Publication
(10) Pub. No.: US 2025/0308163 A1
(43) Pub. Date: Oct. 2, 2025

(54) AUTOMATIC PARAMETERIZATION OF 3D SURFACE TEXTURES IN SYNTHETIC GENERATION SYSTEMS AND APPLICATIONS

(71) Applicant: NVIDIA Corporation, Santa Clara, CA (US)

(72) Inventors: Nicholas Mark Worth SHARP, Seattle, WA (US); Rohan SAWHNEY, Palo Alto, CA (US)

(73) Assignee: NVIDIA Corporation, Santa Clara, CA (US)

(21) Appl. No.: 18/624,442

(22) Filed: Apr. 2, 2024

(51) Int. Cl. G06T 17/20; G06T 3/067; G06T 7/10

(52) U.S. Cl. CPC G06T 17/20; G06T 3/067; G06T 7/10

(57) ABSTRACT

Aspects of this technical solution can allocate one or more portions of a mesh in a three-dimensional (3D) space to one or more processing units associated with the one or more circuits, the mesh associated with a surface of an object in the 3D space, transform, by the one or more of the processing units, one or more of the portions of the mesh from the 3D space into corresponding second meshes in a two-dimensional (2D) space, segment, by the one or more of the processing units, according to a determination that a distortion of a portion of the mesh among the one or more of the portions of the mesh is below a threshold of parameterization, the portion of the mesh into two further portions of the mesh, where the further portions are among the one or more portions of the mesh, and generate, according to a determination that the distortion of the portion of the mesh among the one or more of the portions of the mesh is at or above the threshold of parameterization, an output mesh including the one or more portions of the mesh.

### BACKGROUND

Consumers increasingly demand that computer graphics support a wider range of use cases that require increasingly rapid identification at high accuracy of a wider array of visual information and increasingly rapid processing visual modeling. Concurrently, consumers increasingly demand that computer graphics support a wider range of use cases that require increasingly rapid processing at higher accuracy of visual models and data. However, conventional systems cannot effectively provide such capabilities, due at least to either low speed or low accuracy at high speed (e.g., introduction of noise).

### SUMMARY

Embodiments of the present disclosure relate to systems and methods for using parallel processing architectures, including but not limited to graphics processing units (GPUs), to project surfaces of three-dimensional (3D) objects onto a two-dimensional (2D) plane. Surfaces of a 3D object can include many complex features that can result in destruction of surface features during projection. For example, a 3D object may include a number of surfaces having irregular shapes (e.g., a bone of a vertebrate) or surfaces that include many arbitrary intersections (e.g., a network of tubes or plumbing). Projections of shapes with such irregularities can result in overlap or distortion of those surface features when projected on a 2D plane. Conventional techniques to minimize overlap and distortion require significant manual input, and significant computational resources to perform projections that do not sufficiently mitigate distortion and overlap.

At least one aspect is directed to a processor that can include one or more circuits. The processor can allocate one or more portions of a mesh in a three-dimensional (3D) space to one or more processing units associated with the one or more circuits, the mesh associated with a surface of an object in the 3D space. The processor can transform, by the one or more of the processing units, one or more of the portions of the mesh from the 3D space into corresponding second meshes in a two-dimensional (2D) space. The processor can segment, by the one or more of the processing units, and according to a determination that a distortion of a portion of the mesh among the one or more of the portions of the mesh is below a threshold of parameterization, the portion of the mesh into two further portions of the mesh, where the further portions are among the one or more portions of the mesh. The processor can generate, according to a determination that the distortion of the portion of the mesh among the one or more of the portions of the mesh is at or above the threshold of parameterization, an output mesh that can include the one or more portions of the mesh.

At least one aspect is directed to a method that can include allocating one or more portions of a mesh in a three-dimensional (3D) space to one or more processing units associated with the one or more circuits, the mesh associated with a surface of an object in the 3D space. The method can include transforming, by the one or more of the processing units, one or more of the portions of the mesh from the 3D space into corresponding second meshes in a two-dimensional (2D) space. The method can include segmenting, by the one or more of the processing units, and according to a determination that a distortion of a portion of the mesh among the one or more of the portions of the mesh is below a threshold of parameterization, the portion of the mesh into two further portions of the mesh, where the further portions are among the one or more portions of the mesh. The method can include generating, according to a determination that the distortion of the portion of the mesh among the one or more of the portions of the mesh is at or above the threshold of parameterization, an output mesh that can include the one or more portions of the mesh.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1A depicts an example 3D object in a 3D space in accordance with some embodiments of the present disclosure.

FIG. 1B depicts an example 3D object projected onto a 2D surface in accordance with some embodiments of the present disclosure.

FIG. 2 depicts an example segmented object in accordance with some embodiments of the present disclosure.

FIG. 3 depicts an example irregular segmented object in accordance with some embodiments of the present disclosure.

FIG. 4A depicts an example object mesh in accordance with some embodiments of the present disclosure.

FIG. 4B depicts an example grouped object mesh in accordance with some embodiments of the present disclosure.

FIG. 5A depicts an example object mesh in accordance with some embodiments of the present disclosure.

FIG. 5B depicts an example segmented object mesh in accordance with some embodiments of the present disclosure.

FIG. 6A depicts an example 3D biological model in accordance with some embodiments of the present disclosure.

FIG. 6B depicts an example projected surface of a 3D biological model in accordance with some embodiments of the present disclosure.

FIG. 7A depicts an example 3D human model in accordance with some embodiments of the present disclosure.

FIG. 7B depicts an example projected surface of a 3D human model in accordance with some embodiments of the present disclosure.

FIG. 8A depicts an example 3D mechanical model in accordance with some embodiments of the present disclosure.

FIG. 8B depicts an example projected surface of a 3D mechanical model in accordance with some embodiments of the present disclosure.

FIG. 9 is a block diagram of an example network system to implement parallelized 3D surface parameterization using parallel processing architectures, in accordance with some embodiments of the present disclosure.

FIG. 10 is a block diagram of an example computer system to implement parallelized 3D surface parameterization using parallel processing architectures, in accordance with some embodiments of the present disclosure.

FIG. 11 is a block diagram of an example computer architecture to implement parallelized 3D surface parameterization using parallel processing architectures, in accordance with some embodiments of the present disclosure.

FIG. 12 depicts an example method of 3D surface parameterization in accordance with some embodiments of the present disclosure.

FIG. 13 depicts an example method of 3D surface parameterization in accordance with some embodiments of the present disclosure.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

Parameterizations can store appearance data such as colors, materials, etc., for a 3D mesh in an accompanying image file called a “texture.” The parameterizations create a correspondence between parts of a surface with matching parts of the texture. These parameterizations can be provided as data for a 3D asset, traditionally created manually by technical artists, or generated with significant noise that renders them unusable for many applications. For example, 3D meshes generated from photogrammetry and AI pipelines result in noisy output of low-quality parameterizations not suited for downstream tasks. Likewise, CAD-based techniques result in low-accuracy output, because the distribution of triangles in CAD-based models is highly irregular. However, automatic parameterization can provide technical solutions to enable usage of 3D assets in a variety of applications, ranging from synthetic data generation to improved artist workflows to industrial digital twins. For example, a process according to this disclosure can include a pipeline for automatically creating parameterizations for triangle meshes. In this example, the input is a mesh, and the output is a parameterization for that mesh with a quality that indicates distortion of a texture below a given level. A technical improvement according to the examples of this disclosure includes a graph-based seam-placement strategy that reduces noise in high-resolution meshes.

A technical improvement according to the examples of this disclosure includes a new scheme for dynamically re-parameterizing and placing additional seams to ensure that quality tolerances are reached. For example, quality tolerances can correspond to one or more boundaries of acceptable distortion of a texture or a portion of a texture. A technical improvement according to the examples of this disclosure includes a pipeline system to adaptively distribute computational work, allowing parallelism and high-performance execution of the process. For example, execution of parameterization can be performed across a plurality of processing units, processor cores, or any combination thereof.

Systems and methods in accordance with the present disclosure can more efficiently use computational resources to project complex surfaces from a 3D object onto a 2D place, e.g., by using a parameterization that can be distributed across parallel processors, processor cores, or any combination thereof. For example, a system can operate on a mesh that defines a surface of a complex 3D object, and can perform multiple cutting (e.g., segmenting) operations on the shape to separate the surface into one or more pieces that can be projected onto a 2D plane. For example, the system can place a path along the surface of the 3D object along which the surface is to be separated, and can iteratively shorten the path to optimize the path to a shortened path along one or more edges of the mesh that defines the surface. The system can then further identify subsequent cuts through the 2D surface to generate “islands” that correspond to portions of the surface of the 3D object, and can identify a level of distortion, overlap, or both, of each island. If one or more of the distortion or overlap exceeds an acceptable threshold level, the system can iteratively continue with further cuts to create more islands, and further determinations of whether the distortion or overlap of the subsequent islands meet the acceptable threshold level. Thus, this technical solution repeatedly alternates between flattening and placing additional cuts. This repeated alternating structure provides at least a technical improvement of processing difficult inputs and producing high-quality 2D surface projections of complex polygon mesh maps.

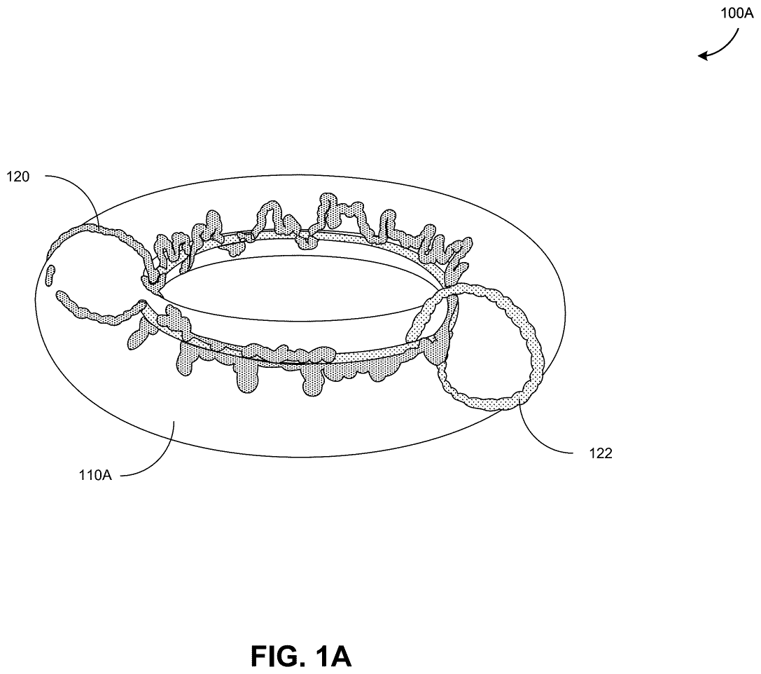

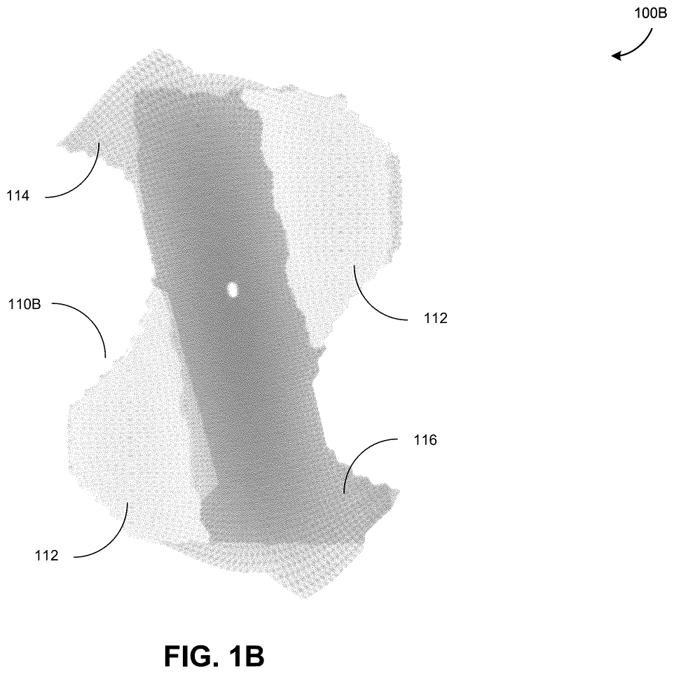

FIG. 1A depicts an example 3D object in a 3D space in accordance with some embodiments of the present disclosure. As illustrated by way of example in FIG. 1A, a 3D object in a 3D space 100A can include at least an object surface 110A. The object surface 110A can define boundaries of a 3D object in a 3D space. For example, the object surface 110A is a visible portion of a 3D object from one or more viewpoints in a 3D environment. The object surface 110A can have visual properties thereon. For example, the object surface 110A can include or have a texture, or be “skinned” with a texture having various colors, patterns, or any combination thereof. The object surface 110A can include a first segmentation path 120, and a second segmentation path 122.

The first segmentation path 120 can correspond to a line or linear shape along the object surface 110A having a first length. For example, the first segmentation path 120 can be a first iteration of a path along the object surface 110A. The object surface 110A can be divided along the first segmentation path 120 into a 2D surface that can be projected onto a 2D plane. The second segmentation path 122 can correspond to a line or linear shape along the object surface 110A having a second length. For example, the second length can be less than the first length. For example, a shorter length can be advantageous for dividing a 3D object into one or more 2D surfaces, and to reduce the amount of computational resources required to project the 2D surfaces onto a 2D plane. As discussed herein, a reduction in the amount of computational resources can include a reduction in the number or processors or processor cores. As discussed herein, a reduction in the amount of computational resources can include a reduction in the amount of power consumed by one or more processors or processor cores. For example, the first segmentation path 120 can be a first iteration of a path along the object surface 110A. The object surface 110A can be divided along the first segmentation path 120 into a 2D surface that can be projected onto a 2D plane. A system as discussed herein can generate the second segmentation path 122 from the first segmentation path 120. A system as discussed herein can generate the second segmentation path 122 after one or more iterations to shorten the first segmentation path 120 according to one or more criteria or metrics as discussed herein.

FIG. 1B depicts an example 3D object projected onto a 2D surface in accordance with some embodiments of the present disclosure. As illustrated by way of example in FIG. 1B, a 3D object projected onto a 2D surface 100B can include at least a projected object surface 110B. The projected object surface 110B can define the object surface 110A in a 2D space. For example, the projected object surface 110B is a 2D surface that is segmented along one or more segmentation paths. For example, the projected object surface 110B is segmented along one or more of the first segmentation path 120 and the second segmentation path 122 to be “flattened” or projected onto a 2D surface. The projected object surface 110B can include a low distortion region 112, a moderate distortion region 114, and a high distortion region 116. As a result of flattening, portions of the projected object surface 110B can be distorted due to a difference in relative position between various points of the projected object surface 110B in a 3D space and in relative position between the various points of the projected object surface 110B in a 2D space (e.g., a “relative positioning” of the points). For example, a relative position of two points in a X direction and a Y direction in Cartesian 3D space can differ from those relative positions in a X direction and a Y direction in Cartesian 2D space.

The low distortion region 112 can correspond to one or more points or portions of the projected object surface 110B in which distortion is below a first threshold. For example, the first threshold is a difference in relative positioning that is indicative of no distortion in a projection of a surface onto a 2D plane. For example, the first threshold is a difference in relative positioning that is indicative of distortion in a projection of a surface onto a 2D plane below a level that is visually perceptible by the naked eye. In other words, the distortion is imperceptible. For example, the low distortion region 112 includes a collection of points defining triangles of a mesh in which all lines on the object surface 110A are the same as on the projected object surface 110B.

The moderate distortion region 114 can correspond to one or more points or portions of the projected object surface 110B in which distortion is below a second threshold. For example, the second threshold is a difference in relative positioning that is indicative of perceptible distortion in a projection of a surface onto a 2D plane. For example, the second threshold is a difference in relative positioning that is indicative of distortion in a projection of a surface onto a 2D plane above a level that is visually perceptible by the naked eye and below a level that indicates a deformation in at least a portion of a shape. For example, the moderate distortion region 114 includes a collection of points defining triangles of a mesh in which a majority of lines on the object surface 110A are the same as on the projected object surface 110B.

The high distortion region 116 can correspond to one or more points or portions of the projected object surface 110B in which distortion is at or above the second threshold. For example, the moderate distortion region 114 includes a collection of points defining triangles of a mesh in which a minority of lines or no line on the object surface 110A are the same as on the projected object surface 110B.

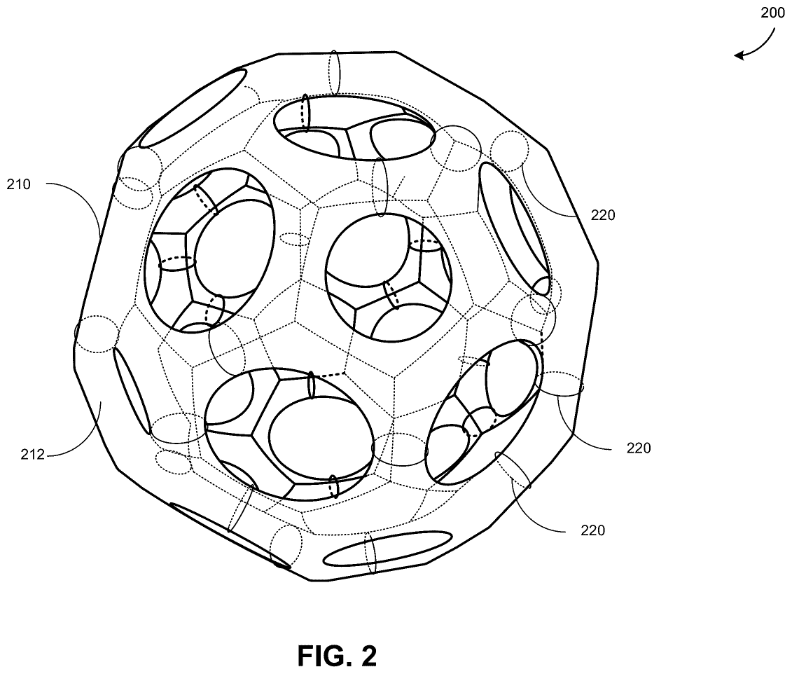

FIG. 2 depicts an example segmented object in accordance with some embodiments of the present disclosure. As illustrated by way of example in FIG. 2, a segmented object 200 can include at least a segmented 3D object 210. The segmented 3D object 210 can have an object surface 212 corresponding to the object surface 110A, and one or more segmentation paths 220. The segmentation paths 220 can separate portions of the object surface 212 into a plurality of portions by one or more segmentation paths. For example, a system as discussed herein can generate a plurality of initial segmentation paths on the object surface 212 of an initial 3D object corresponding to the segmented 3D object 210. The initial segmentation paths can each correspond at least partially in one or more of structure and operation to first segmentation path 120 (of FIG. 1A). The system can then modify one or more of the initial segmentation paths according to one or more iterations to reduce the length of those initial segmentation paths, to result in the segmentation paths 220. For example, the system can allocate optimization of one or more of the segmentation paths to one or more corresponding processors or processor cores. For example, the system can allocate optimization of one or more of the segmentation paths to one or more corresponding processors or processor cores based on processor availability, computational capacity, processor core heat level, core type, processor type, or any combination thereof. Thus, the segmented 3D object 210 can include one or more segmentation paths 220 optimized for the 3D topology of the segmented 3D object 210.

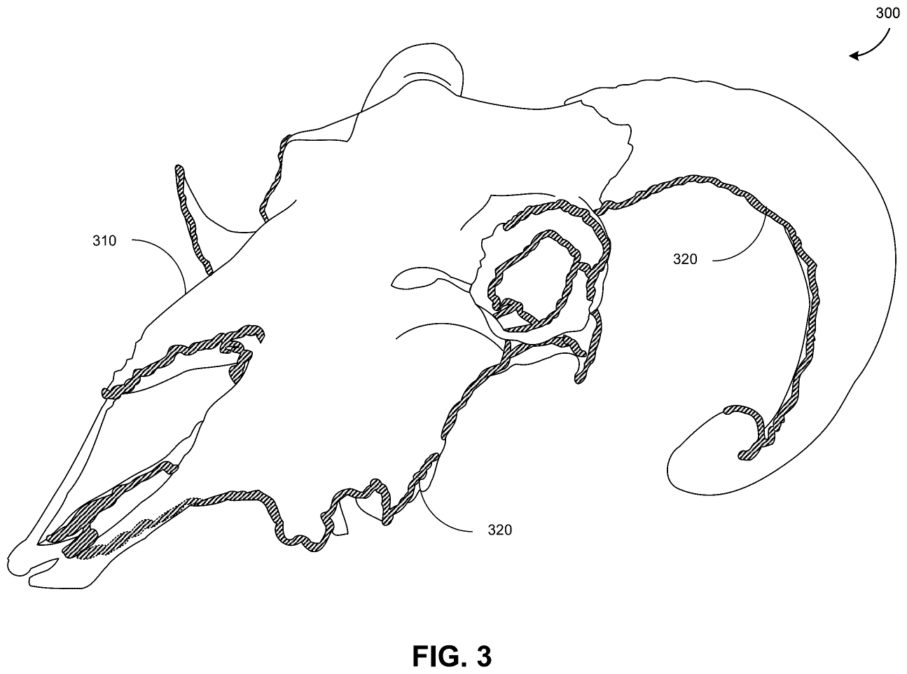

FIG. 3 depicts an example irregular segmented object in accordance with some embodiments of the present disclosure. As illustrated by way of example in FIG. 3, an irregular segmented object 300 can include at least an irregular segmented 3D object 310.

The irregular segmented 3D object 310 can have one or more portions with shapes different than shapes of regular polygons, polyhedrons, or spherical objects, for example. For example, the irregular segmented 3D object 310 is a 3D model of a skull of cow. The irregular segmented 3D object 310 can include partial segmentation paths 320. The partial segmentation paths 320 can partially separate portions of the object surface of an initial 3D object corresponding to the irregular segmented 3D object 310, to, for example, open a shape to allow a greater percentage of the surface area of that shape to be projected on a 2D plane without or with reduced interference as discussed herein. For example, a system as discussed herein can generate a plurality of the partial segmentation paths 320 along the object surface of a 3D object corresponding to the irregular segmented 3D object 310. For example, each of the partial segmentation paths 320 is a path through the initial 3D object corresponding to the irregular segmented 3D object 310 that does not segment the object surface of the initial 3D object into a plurality of distinct surfaces. In contrast, the segmentation paths 220 can segment or “cut” a surface into a plurality of segments as discussed herein.

For example, the system can place the partial segmentation paths 320 at portions of the shape having a curvature at or above a given curvature threshold. For example, a curvature threshold can indicate a curvature of a point, ridge, edge, or any combination thereof. The generation of partial segmentation paths at portions of an object surface having the curvature discussed herein can provide a technical improvement to segment a shape for texturization such that any discontinuity in texture (e.g., a “seam” in a texture) can be reduced or eliminated, as compared to a discontinuity through a flat or smooth portion of a surface of an irregular object surface. Thus, the partial segmentation paths 320 can separate portions of an object surface while maintaining contiguity of the object surface. For example, the system can allocate optimization of one or more of the partial segmentation paths 320 to one or more corresponding processors or processor cores based on processor availability, computational capacity, processor core heat level, core type, processor type, or any combination thereof. The system can then generate one or more segmentations paths 220 on the object surface of the initial 3D object that has been opened according to the segmentation paths 220.

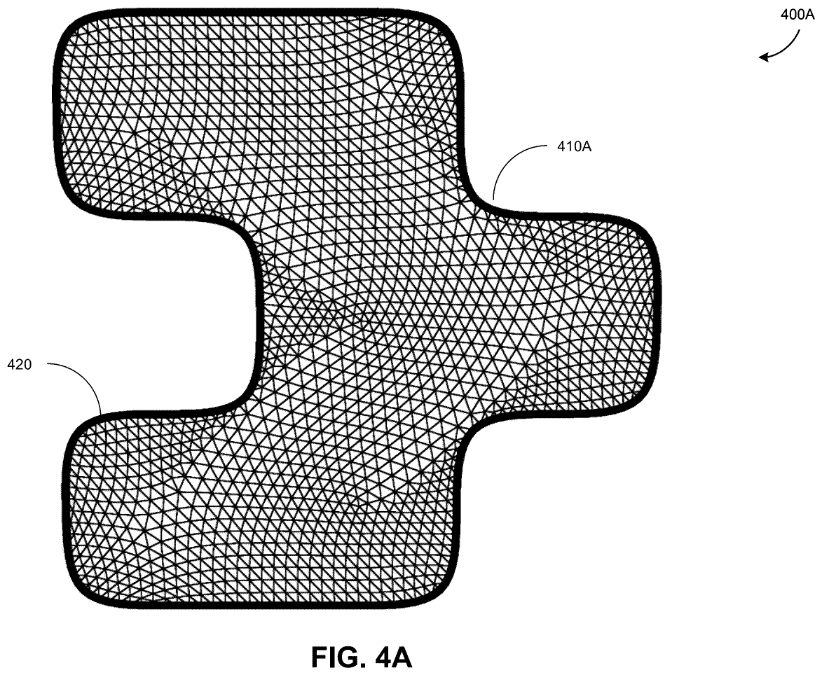

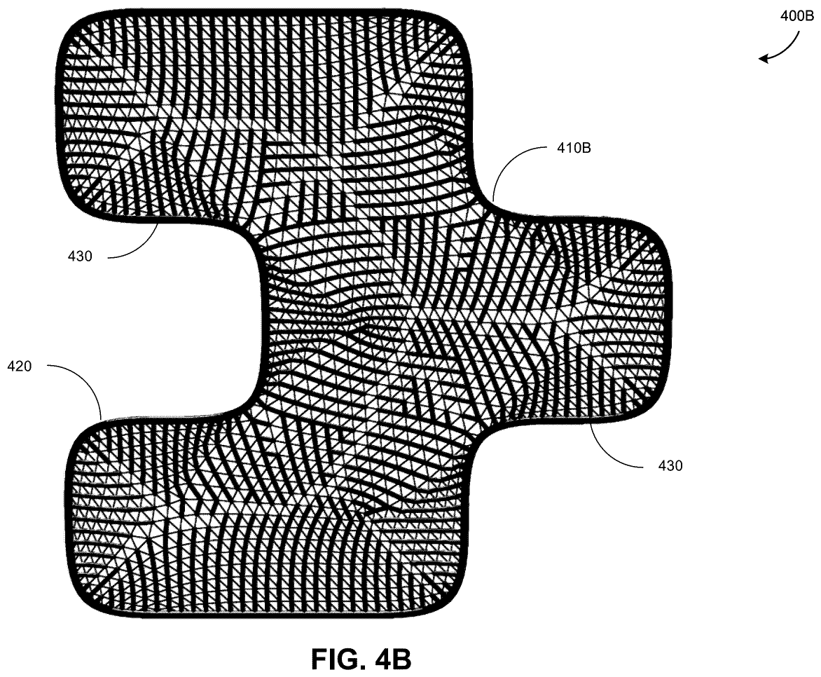

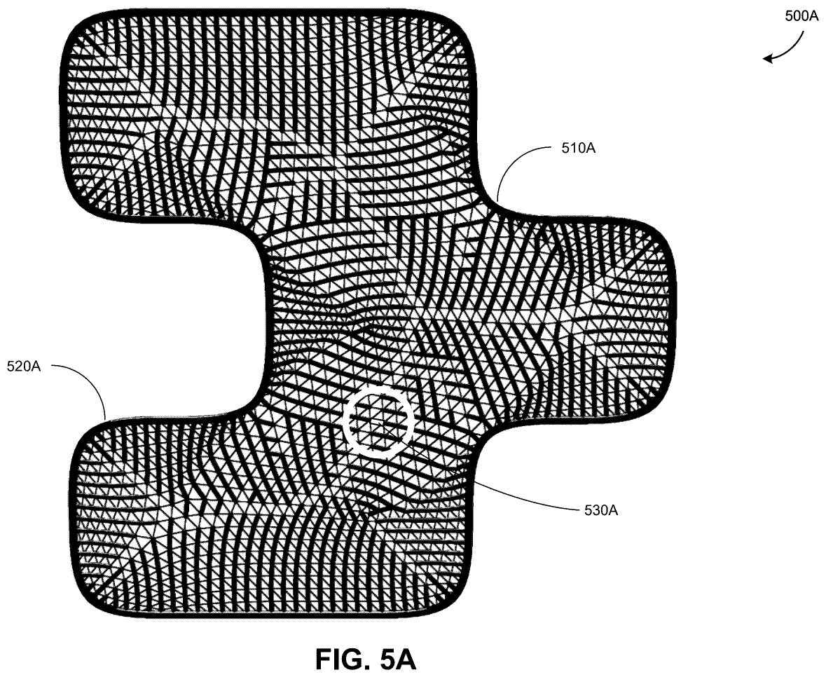

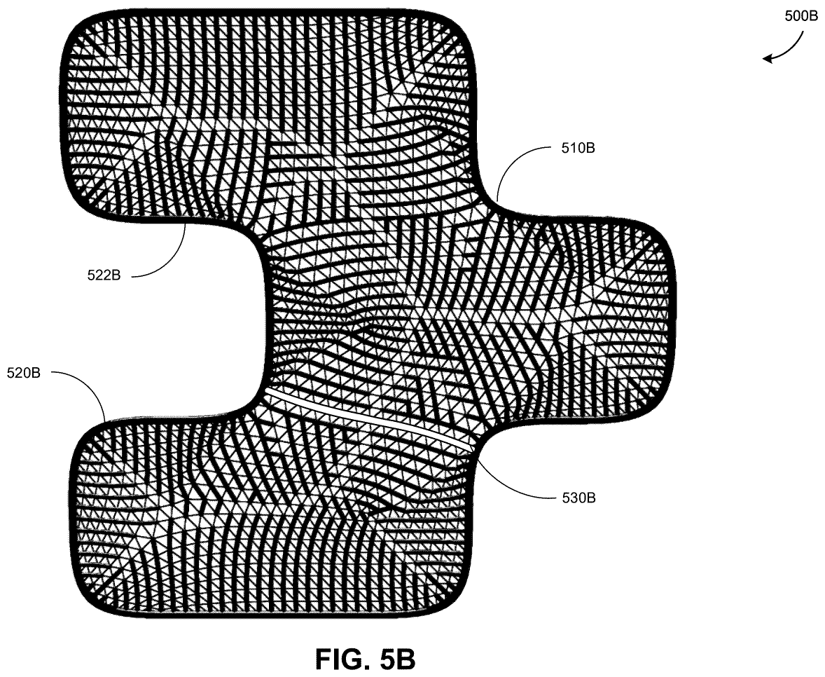

FIGS. 4A-5B are directed to segmenting a surface of a 3D object and are illustrated by way of example in a 2D view for illustrative purposes. As depicted in FIGS. 4A-5B, an object surface includes a plurality of edges connected with a plurality of nodes in an arrangement that forms a mesh of triangles that collectively define the object surface of a 3D object. The object surface according to this disclosure is not limited to the triangular mesh illustrated in in FIGS. 4A-5B by way of example.

FIG. 4A depicts an example object mesh in accordance with some embodiments of the present disclosure. As illustrated by way of example in FIG. 4A, an object mesh 400A can include at least a surface mesh 410A. The surface mesh 410A can define an object surface or a segment of a segmented object surface as discussed herein. The surface mesh 410A can be or include a triangle mesh as discussed herein, but is not limited thereto. The surface mesh 410A can include a surface boundary 420. For example, a system as discussed herein can form the surface mesh 410A from a portion of a 3D object having an object surface that is a triangle mesh. The surface boundary 420 can define a termination of the surface mesh 410A. For example, the surface boundary 420 includes a plurality of edges of the triangle mesh along a perimeter of the surface mesh 410A.

FIG. 4B depicts an example grouped object mesh in accordance with some embodiments of the present disclosure. As illustrated by way of example in FIG. 4B, a grouped object mesh 400B can include at least a surface mesh 410B. The surface mesh 410B can correspond at least partially in one or more of structure and operation to the surface mesh 410A. The surface mesh 410B can include a plurality of surface mesh groups 430. The object mesh 400B can correspond to a state subsequent to the object mesh 400A. A system as discussed herein can perform one or more actions on the surface mesh 410A to generate or obtain the surface mesh 410B.

The surface mesh groups 430 can define portions of the surface mesh 410B that have similar or like topological properties. For example, the surface mesh groups 430 can each include edges and nodes of corresponding portions of the surface mesh 410B that are at or below a curvature threshold. For example, a system can define surface mesh groups 430 according to a determination that edges within a given distance from each other are at or below the curvature threshold. For example, a system can define surface mesh groups 430 by determining that curvature of edges within a given distance of a given point on the surface mesh 410B are at or below the curvature threshold. For example, the system can allocate one or more edges to one or more corresponding processors or processor cores based on processor availability, computational capacity, processor core heat level, core type, processor type, or any combination thereof. For example, surface mesh groups can be defined according to a determination based on at least one of edge length, curvature, or proximity to one or more given boundaries at least as discussed herein. Thus, this technical solution can include a technical improvement to identify and group portions of a triangular mesh according to the topology of the mesh, and to achieve the grouping at an accuracy and speed beyond the capability of manual processes.

FIG. 5A depicts an example object mesh in accordance with some embodiments of the present disclosure. As illustrated by way of example in FIG. 5A, an object mesh 500A can include at least a surface mesh 510A, and a mesh segment 530A. The object mesh 500A can correspond to a state subsequent to the object mesh 400B. A system as discussed herein can perform one or more actions on the surface mesh 410B to generate or obtain the surface mesh 510A. The surface mesh 510A can correspond at least partially in one or more of structure and operation to the surface mesh 410B, and can include a surface boundary 520A. For example, the surface mesh 510A is at least a portion of a surface of a 3D object, before partial segmentation or segmentation of the surface mesh 510A. The surface boundary 520A can correspond at least partially in one or more of structure and operation to the surface boundary 420. For example, the surface boundary 520A is at least a portion of a perimeter surface of a 3D object, before partial segmentation or segmentation of the surface mesh 510A.

The mesh segment 530A can identify an edge of the surface mesh 510A that satisfies a criterion for segmentation. For example, a system as discussed herein can identify or select the mesh segment 530A, according to an edge criterion. For example, the edge criterion is a threshold for a distance between surface mesh groups. For example, a system can determine a distance criterion for each edge in a surface mesh, and can select one or more edges having distances satisfying the edge criterion. For example, a system can determine a distance criterion for each edge in a surface mesh, and can select at least one edge having a shortest distance. For example, a distance can be measured in number of edges, aggregate length of each edge in a 2D coordinate space, aggregate length of each edge in a 3D coordinate space, or any combination thereof. For example, the system can allocate determination of distances one or more edges to one or more corresponding processors or processor cores based on processor availability, computational capacity, processor core heat level, core type, processor type, or any combination thereof.

FIG. 5B depicts an example segmented object mesh in accordance with some embodiments of the present disclosure. As illustrated by way of example in FIG. 5B, a segmented object mesh 500B can include at least a segmented surface mesh 510B, segmented surface mesh boundaries 520B and 522B, and an extended mesh boundary 530B. For example, the surface mesh 510B is at least a portion of a surface of a 3D object, after partial segmentation or segmentation of the surface mesh 510A. The segmented surface mesh 510B can correspond at least partially in one or more of structure and operation to the segmented surface mesh 510A. The object mesh 500A can correspond to a state subsequent to the object mesh 400B. A system as discussed herein can perform one or more actions on the surface mesh 510A to generate or obtain the surface mesh 510B.

The segmented surface mesh boundaries 520B and 522B can correspond to portions of the surface boundary 520A after segmentation along the extended mesh boundary 530B. Thus, the segmented surface mesh boundary 520B and the extended mesh boundary 530B can form a boundary of a first segment of the segmented surface mesh 510B, and the segmented surface mesh boundary 522B and the extended mesh boundary 530B can form a boundary of a second segment of the segmented surface mesh 510B. The extended mesh boundary 530B can correspond at least partially in one or more of structure and operation to a segmentation path as discussed herein. For example, the extended mesh boundary 530B includes the mesh segment 530A. For example, a system as discussed herein identifies the extended mesh boundary 530B as a segmentation path that includes the mesh segment 530A and has one or more terminations at the mesh boundary 520A or 520B of the surface mesh 510A. For example, the system iterates from a first segmentation path that has a length greater than the extended mesh boundary 530B, according to FIG. 5B.

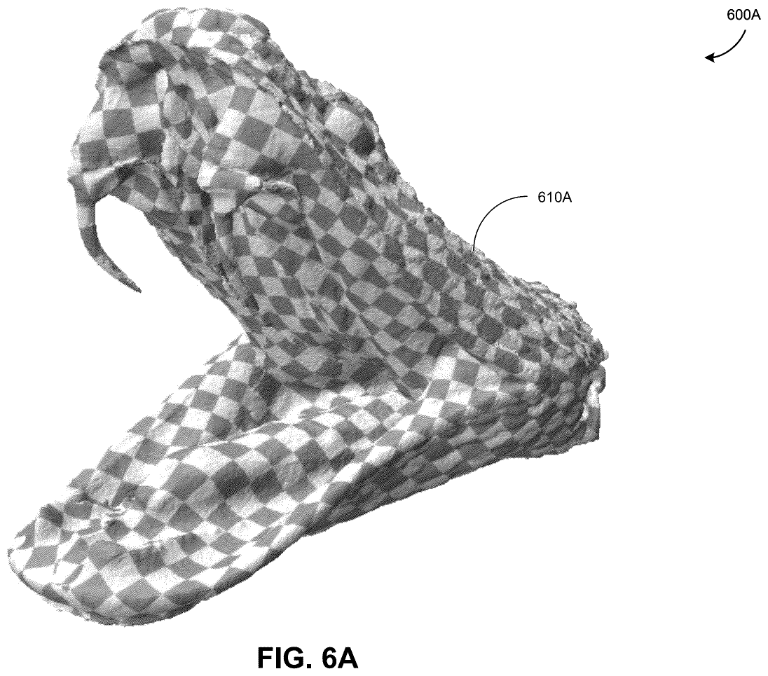

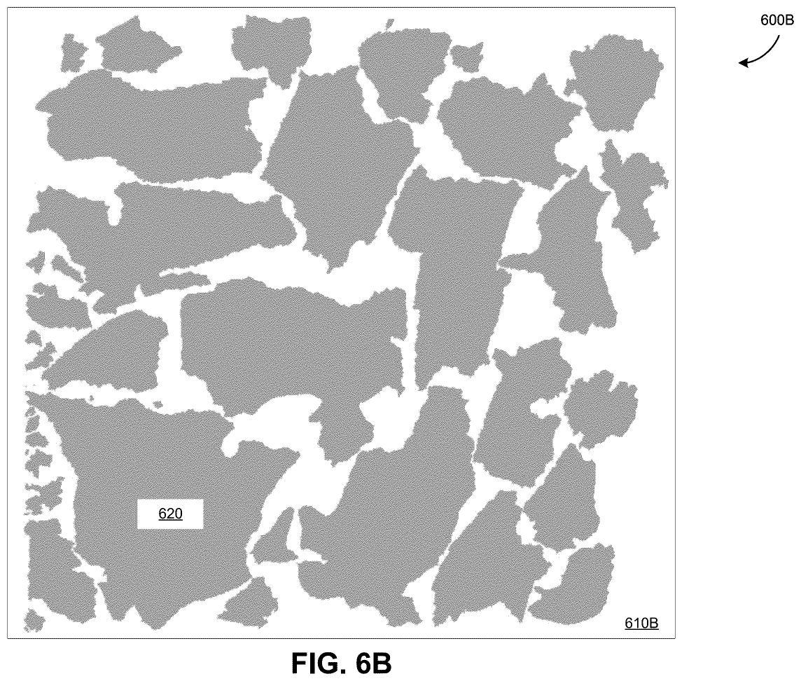

FIG. 6A depicts an example 3D biological model in accordance with some embodiments of the present disclosure. As illustrated by way of example in FIG. 6A, a 3D biological model 600A can include at least a model surface 610A. The model surface 610A can define a surface of a 3D model having a first irregular shape. For example, the model surface 610A is a mesh surface indicative of a snake head with an open mouth. The model surface 610A can include a plurality of portions with high curvature. For example, high curvature portions of the snake head include the fangs, lips, and eyes.

FIG. 6B depicts an example projected surface of a 3D biological model in accordance with some embodiments of the present disclosure. As illustrated by way of example in FIG. 6B, a projected surface 600B of a 3D biological model can include at least a surface projection 610B, and surface segments 620. For example, a system as discussed herein segments the model surface 610A into a plurality of surface meshes and iteratively projects the surface meshes onto a 2D plane to generate or obtain the projected surface 600B. The surface projection 610B can correspond to a projection of the model surface 610A onto a 2D coordinate space from a 3D coordinate space. The surface segments 620 can each correspond to portions of the model surface 610A as projected onto the 2D coordinate space. For example, the surface segments 620 are portions of the snake head model surface segmented along one or more lines of high curvature (e.g., fangs) and projected onto the 2D coordinate space according to a minimum distortion for each of the surface segments 620 as discussed herein.

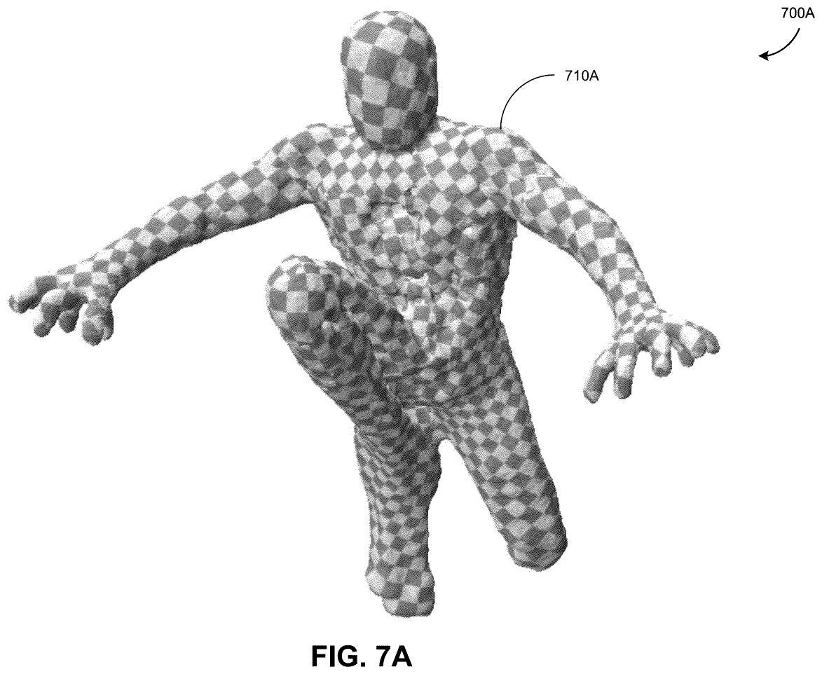

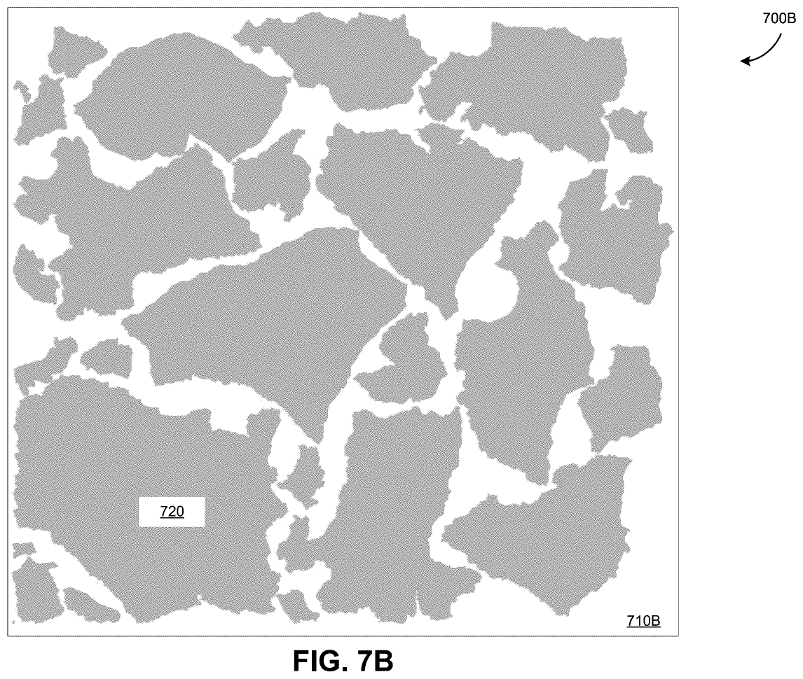

FIG. 7A depicts an example 3D human model in accordance with some embodiments of the present disclosure. As illustrated by way of example in FIG. 7A, a 3D human model 700A can include at least a model surface 710A. The model surface 710A can define a surface of a 3D model having a second irregular shape. For example, the model surface 710A is a mesh surface indicative of a human figure in an athletic pose. The model surface 710A can include a plurality of portions with high curvature. For example, high curvature portions of the human figure include the fingers, neck and limb-torso intersections.

FIG. 7B depicts an example projected surface of a 3D human model in accordance with some embodiments of the present disclosure. As illustrated by way of example in FIG. 7B, a projected surface of a 3D human model 700B can include at least a surface projection 710B, and surface segments 720. For example, a system as discussed herein segments the model surface 710A into a plurality of surface meshes and iteratively projects the surface meshes onto a 2D plane to generate or obtain the projected surface 700B. The surface projection 710B can correspond to a projection of the model surface 710A onto a 2D coordinate space from a 3D coordinate space. The surface segments 720 can each correspond to portions of the model surface 710A as projected onto the 2D coordinate space. For example, the surface segments 720 are portions of the human figure model surface segmented along one of more lines of high curvature (e.g., fingers) and projected onto the 2D coordinate space according to a minimum distortion for each of the surface segments 720 as discussed herein.

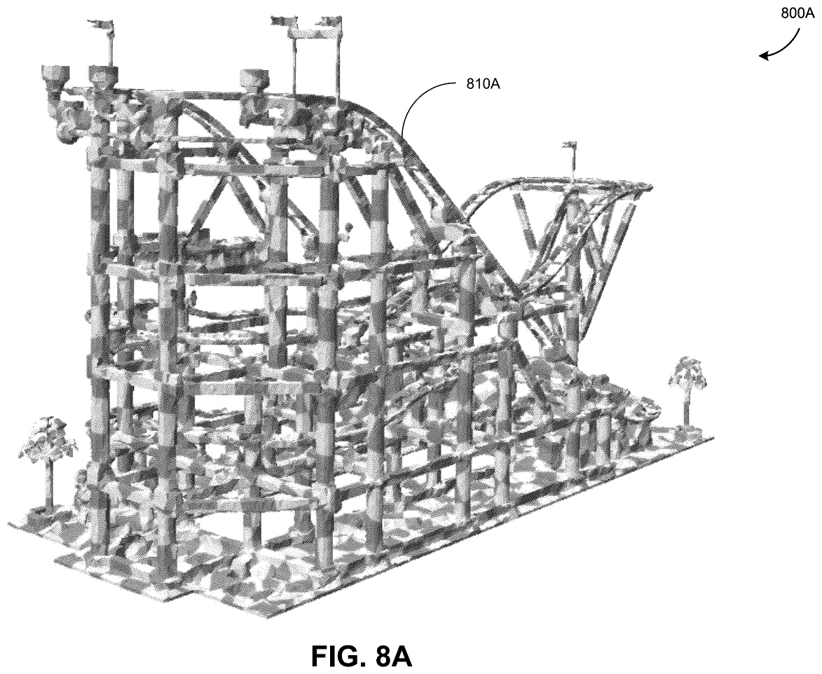

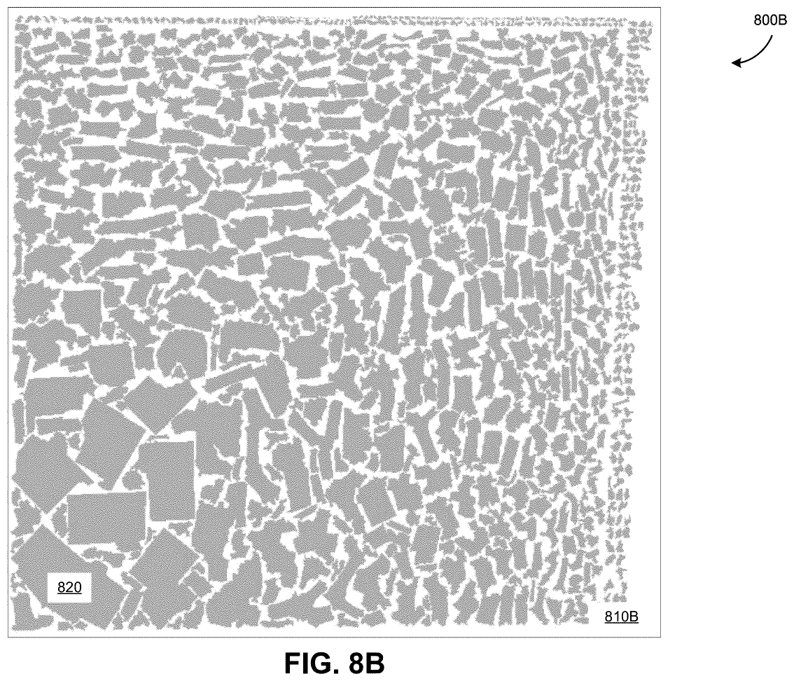

FIG. 8A depicts an example 3D mechanical model in accordance with some embodiments of the present disclosure. As illustrated by way of example in FIG. 8A, a 3D mechanical model 800A can include at least a model surface 810A. The model surface 810A can define a surface of a 3D model having a third irregular shape. For example, the model surface 810A is a mesh surface indicative of a mechanical structure of a rollercoaster. The model surface 810A can include a plurality of portions with high curvature. For example, high curvature portions of the mechanical structure include the tubes, flagpoles, support rings, and rails. Here, the model surface 810A includes a prevalence of high-curvature portions that exceeds that of the model surface 610A of FIG. 6A and the model surface 710A of FIG. 7A.

FIG. 8B depicts an example projected surface of a 3D mechanical model in accordance with some embodiments of the present disclosure. As illustrated by way of example in FIG. 8B, a projected surface of a 3D mechanical model 800B can include at least a surface projection 810B, and surface segments 820. For example, a system as discussed herein segments the model surface 810A into a plurality of surface meshes and iteratively projects the surface meshes onto a 2D coordinate space to generate or obtain the projected surface 800B. The surface projection 810B can correspond to a projection of the model surface 810A onto a 2D coordinate space from a 3D coordinate space. The surface segments 820 can each correspond to portions of the model surface 810A as projected onto the 2D coordinate space. For example, the surface segments 820 are portions of the mechanical model surface segmented along one of more lines of high curvature (e.g., tubes, flagpoles, support rings, rails) and projected onto the 2D coordinate space according to a minimum distortion for each of the surface segments 820 as discussed herein.

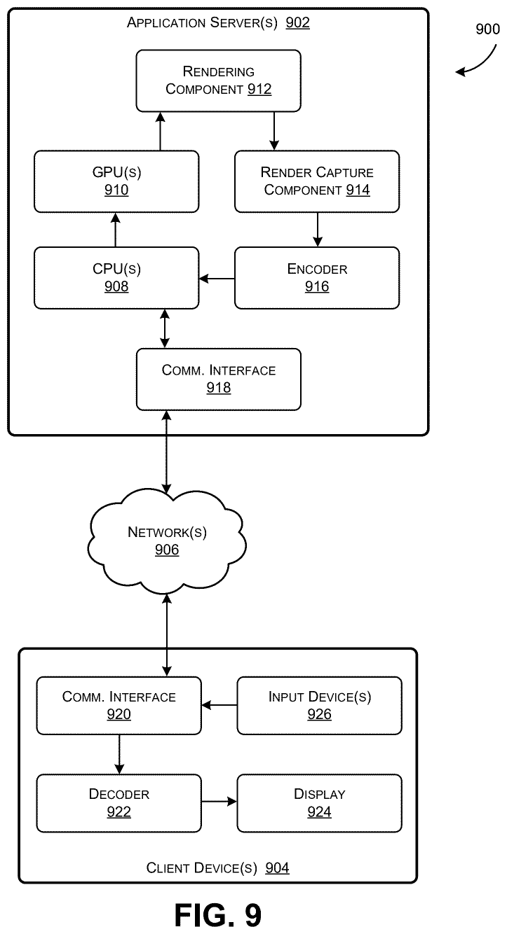

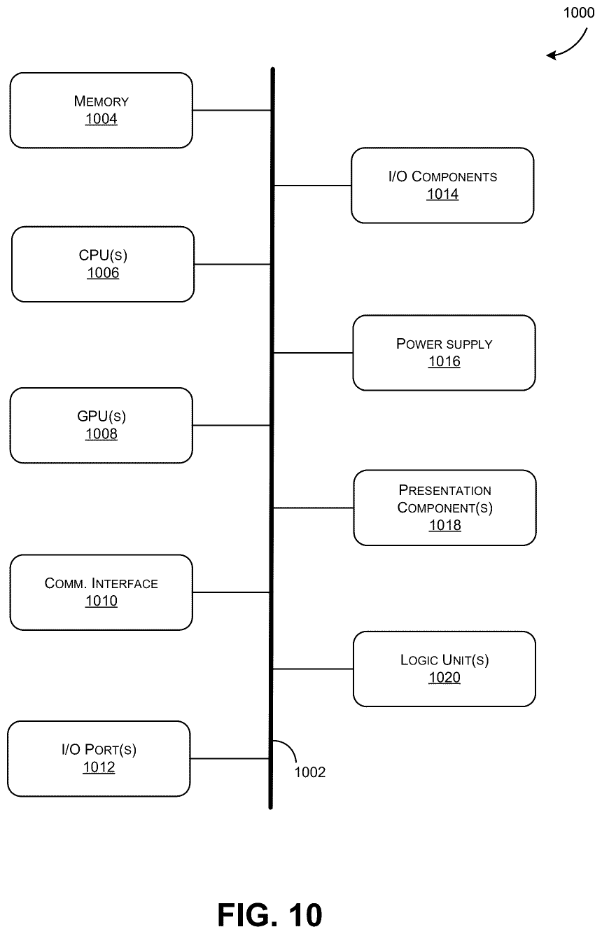

FIG. 9 depicts an example network system, according to the present disclosure. As illustrated by way of example in FIG. 9, an example network system 900 can include at least application server(s) 902 (which may include similar components, features, and/or functionality to the example computing device 1000 of FIG. 10), client device(s) 904 (which may include similar components, features, and/or functionality to the example computing device 1000 of FIG. 10), and network(s) 906 (which may be similar to the network(s) described herein). In some embodiments of the present disclosure, the system 900 may be implemented to perform diffusion model training and runtime operations. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 900 can be implemented to update a population of solutions by a parallelized processor architecture.

In the system 900, for an application session, the client device(s) 904 may only receive input data in response to inputs to the input device(s) 926, transmit the input data to the application server(s) 902, receive encoded display data from the application server(s) 902, and display the display data on the display 924. As such, the more computationally intense computing and processing is offloaded to the application server(s) 902 (e.g., rendering—in particular, ray or path tracing—for graphical output of the application session is executed by the GPU(s) of the application server(s) 902). In other words, the application session is streamed to the client device(s) 904 from the application server(s) 902, thereby reducing the requirements of the client device(s) 904 for graphics processing and rendering.

For example, with respect to an instantiation of an application session, a client device 904 may be displaying a frame of the application session on the display 924 according to receiving the display data from the application server(s) 902. The client device 904 may receive an input to one of the input device(s) 926 and generate input data in response. The client device 904 may transmit the input data to the application server(s) 902 according to the communication interface 920 and over the network(s) 906 (e.g., the Internet), and the application server(s) 902 may receive the input data according to the communication interface 918. The CPU(s) 908 may receive the input data, process the input data, and transmit data to the GPU(s) 910 that causes the GPU(s) 910 to generate a rendering of the application session. For example, the input data may be representative of a movement of a character of the user in a game session of a game application, firing a weapon, reloading, passing a ball, turning a vehicle, etc. The rendering component 912 may render the application session (e.g., representative of the result of the input data), and the render capture component 914 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 902. In some embodiments, one or more virtual machines (VMs)—e.g., including one or more virtual components, such as vGPUs, vCPUs, etc.—may be used by the application server(s) 902 to support the application sessions. The encoder 916 may then encode the display data to generate encoded display data and the encoded display data may be transmitted to the client device 904 over the network(s) 906 according to the communication interface 918. The client device 904 may receive the encoded display data according to the communication interface 920 and the decoder 922 may decode the encoded display data to generate the display data. The client device 904 may then display the display data according to the display 924.

FIG. 10 depicts an example computer system, according to the present disclosure. As illustrated by way of example in FIG. 10, an example computer system 1000 can include at least an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected according to the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may be arranged in various topologies, including but not limited to bus, star, ring, mesh, tree, or hybrid topologies. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system). Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal, such as a carrier wave or other transport mechanism, and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

As discussed herein, one or more solutions or one or more populations, or any portion thereof, can be allocated to one or more of the GPU(s) 1008 or any portion thereof. In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., one or more of the CPU(s) 1006 and/or one or more of the GPU(s) 1008 may be a discrete GPU). In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received according to a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., according to a link). The link may directly connect the GPUs (e.g., using NVLINK) or may connect the GPUs through a switch (e.g., using NVSwitch). When combined, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices according to an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008. In some embodiments, a plurality of computing devices 1000 or components thereof, which may be similar or different to one another in various respects, can be communicatively coupled to transmit and receive data for performing various operations described herein, such as to facilitate latency reduction.

The I/O ports 1012 may allow the computing device 1000 to be logically coupled to other devices including the I/O components 1014, the presentation component(s) 1018, and/or other components, some of which may be built into (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice commands, or other physiological inputs generated by a user. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

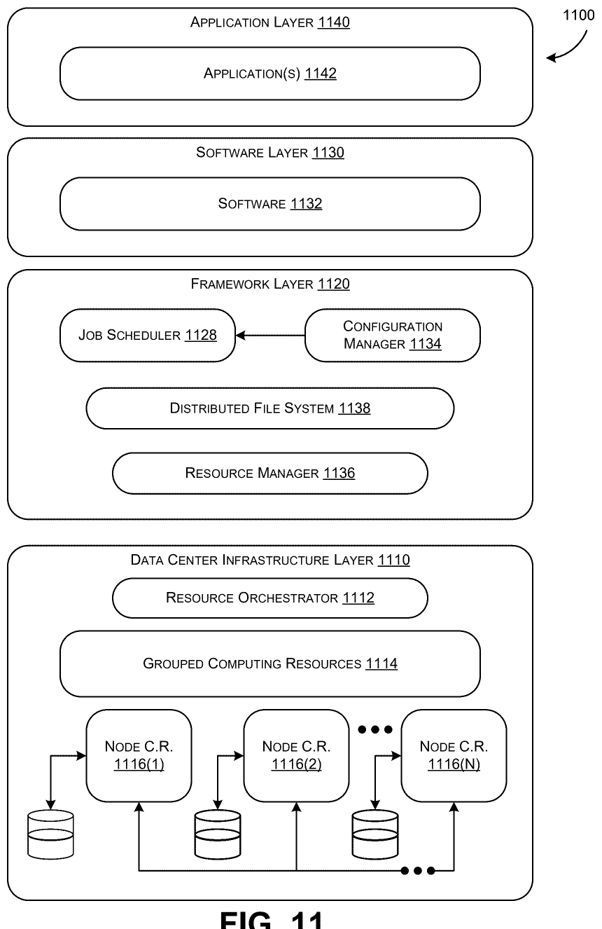

FIG. 11 depicts an example computer architecture, according to the present disclosure. As illustrated by way of example in FIG. 11, an example data center 1100 can include at least a data center infrastructure layer 1110, a framework layer 1120, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-1116(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1120 may include a job scheduler 1128, a configuration manager 1134, a resource manager 1136, and/or a distributed file system 1138. The framework layer 1120 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1120 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1128 may include a Spark driver to facilitate scheduling of workloads supported by various layers of data center 1100. The configuration manager 1134 may be capable of configuring different layers, such as software layer 1130 and framework layer 1120, including Spark and distributed file system 1138 for supporting large-scale data processing. The resource manager 1136 may be capable of managing clustered or grouped computing resources mapped to or allocated for support of distributed file system 1138 and job scheduler 1128. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1120. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1120. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to train, configure, update, and/or execute machine learning models of one or more components of the system 1100. For example, the system 110 can be a data center 1100.

In at least one embodiment, any of configuration manager 1134, resource manager 1136, and resource orchestrator 1112 may implement any number and type of self-modifying actions according to any amount and type of data acquired in any technically feasible fashion. Self-modifying actions may relieve a data center operator of data center 1100 from making poor configuration decisions and may avoid underutilized and/or poorly performing portions of a data center.

The data center 1100 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 900 of FIG. 9—e.g., each device may include similar components, features, and/or functionality of the computing device(s) 900. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 900 described herein with respect to FIG. 9. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

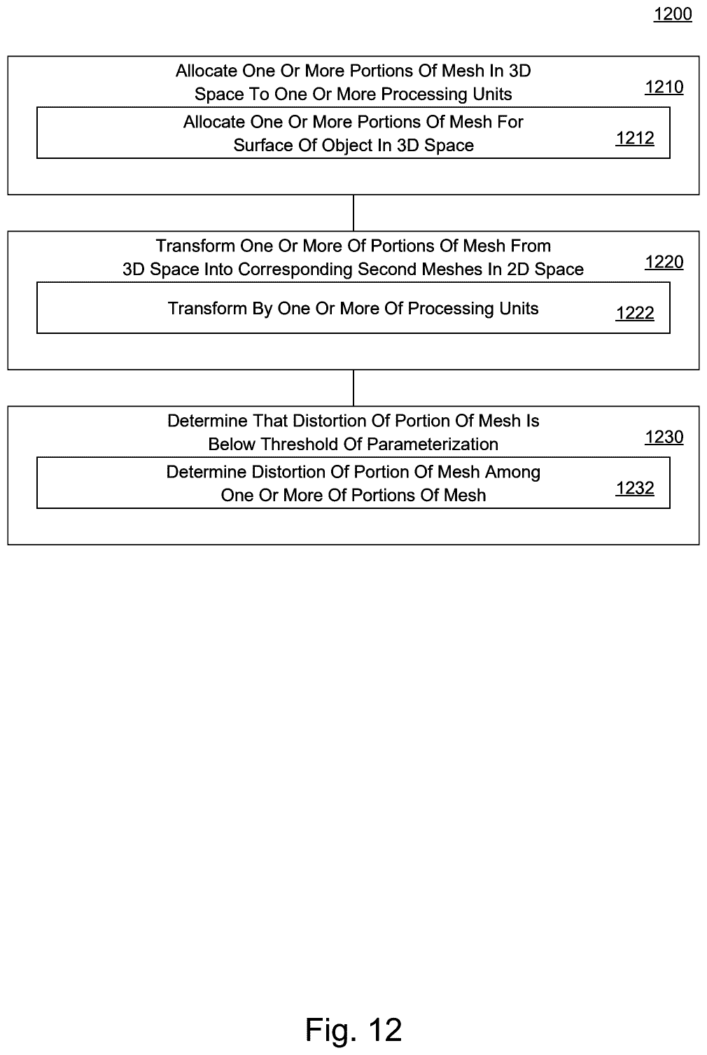

FIG. 12 depicts an example method 1200 of 3D surface parameterization in accordance with some embodiments of the present disclosure. At least a system according to at least one of FIGS. 9-11 can perform method 1200.

At 1210, the method 1200 can allocate one or more portions of a mesh in a 3D space to one or more processing units. At 1212, the method 1200 can allocate one or more portions of the mesh for a surface of an object in the 3D space. For example, the method can allocate one or more portions to various processors or processor cores as discussed herein.

At 1220, the method 1200 can transform one or more of the portions of the mesh from the 3D space into corresponding second meshes in a 2D space. At 1222, the method 1200 can transform one or more of the portions of the mesh by the one or more of the processing units. For example, an allocated processing unit for each of the one or more of the portions of the mesh can transform its corresponding portion of the mesh.

At 1230, the method 1200 can determine that a distortion of a portion of the mesh is below a threshold of parameterization. At 1232, the method 1200 can determine the distortion of the portion of the mesh among the one or more of the portions of the mesh. For example, the system can determine distortion according to one or more of the thresholds and metrics discussed herein.

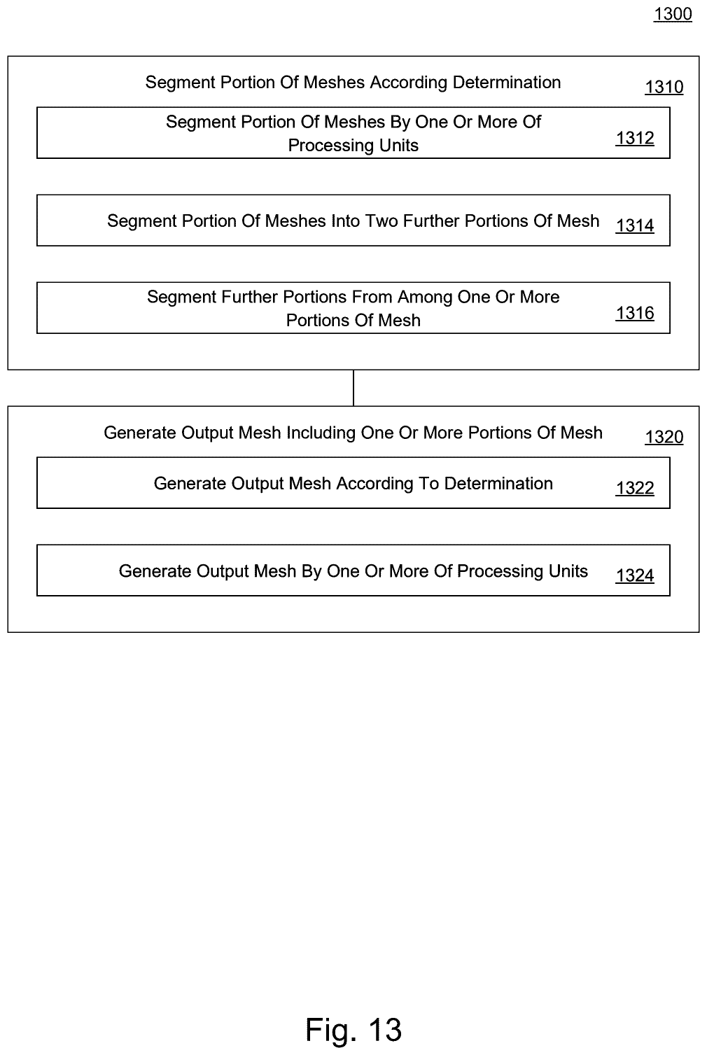

FIG. 13 depicts an example method 1300 of 3D surface parameterization in accordance with some embodiments of the present disclosure. At least a system according to at least one of FIGS. 9-11 can perform method 1300.

At 1310, the method 1300 can segment the portion of the meshes according to the determination 1230. At 1312, the method 1300 can segment the portion of the meshes by the one or more of the processing units. At 1314, the method 1300 can segment the portion of the meshes into two further portions of the mesh. At 1316, the method 1300 can segment the further portions from among the one or more portions of the mesh.

At 1320, the method 1300 can generate an output mesh including the one or more portions of the mesh. At 1322, the method 1300 can generate the output mesh according to the determination. At 1324, the method 1300 can generate the output mesh by the one or more of the processing units.

For example, the method can include segmenting, by the one or more of the processing units, according to a path along one or more edges of the mesh, the mesh into the one or more portions of the mesh. For example, the processor can segment, by the one or more of the processing units, according to a path along one or more edges of the mesh, the mesh into the one or more portions of the mesh. For example, the method can include segmenting the mesh according to a determination that the mesh or the object is a topological sphere that cannot be flattened. For example, the processor can segment the mesh according to a determination that the mesh or the object is a topological sphere that cannot be flattened.

For example, the method can include identifying, by the one or more of the processing units, a node of the mesh. The method can include determining, by the one or more of the processing units, the path through the node. For example, the processor can identify, by the one or more of the processing units, a node of the mesh. The method can include determining, by the one or more of the processing units, the path through the node. For example, the node is located at a position in the mesh having a curvature meeting a threshold associated with a curvature of the mesh in the 3D space.

For example, the method can include generating, according to a determination that the overlap of the two or more of the portions of the mesh is at or above the second threshold of parameterization, the output mesh including the one or more portions of the mesh. For example, the processor can segment, by the one or more of the processing units, according to a determination that an overlap of two or more of the portions of the mesh is below a second threshold of parameterization, the portion of the meshes into two further portions of the mesh, the further portions among the one or more portions of the mesh. For example, the processor can generate, according to a determination that the overlap of the two or more of the portions of the mesh is at or above the second threshold of parameterization, the output mesh can include the one or more portions of the mesh. For example, overlap can correspond to location of two nodes or edges in 3D coordinate space in different places, that are projected to a same location in a 2D coordinate space. For example, a first object located above a second object in a Z direction would not be in a same place in a 3D coordinate system including XYZ axes. However, the first object and the second object would at least partially occupy the same location when projected onto a 2D coordinate space including YX axes. The threshold of parameterization can correspond to a quantitative degree of the overlap (e.g., a percentage of overlap of two distinct meshes or mesh groups, or a number of edges or nodes that overlap between two distinct meshes or mesh groups).

For example, the method can include segmenting, by the one or more of the processing units, the portion of the meshes into two further portions of the mesh, the further portions among the one or more portions of the mesh. For example, the method can include segmenting the further portions among the one or more portions of the mesh, according to a determination that an overlap of two or more of the portions of the mesh is below a second threshold of parameterization. For example, the second threshold of parameterization can indicate a quantitative degree of overlap (or projection error) that is acceptable in a projection model. For example, a difference between sizes of the two further portions of the mesh meets an equality threshold associated with a difference in size between the two further portions of the mesh. For example, the system is configured to generate or obtain segments that are roughly equal in size to each other, to optimize the iterative segmentation and provide a technical improvement of one or more of rapid projection with reduced computational resources, processors, processor cores, and energy consumption.

For example, the threshold of parameterization indicates that the portion of the mesh is inverted in at least one direction, from the 3D space to the 2D space. For example, an inversion occurs when a projection of a 3D objects becomes a mirror-image of the position of the 3D object in the 3D coordinate space. For example, a shape can be projected to face the opposite direction in a 2D coordinate space.

For example, the processor is comprised in at least one of a system that can include one or more language models, such as one or more large language models (LLMs) and/or one or more vision language models (VLMs). The system can include one or more generative artificial intelligence (AI) models. The system can include a control system for an autonomous or semi-autonomous machine. The system can include a perception system for an autonomous or semi-autonomous machine. The system can include a system for performing simulation operations. The system can include a system for performing digital twin operations. The system can include a system for performing light transport simulation. The system can include a system for performing collaborative content creation for 3D assets. The system can include a system for performing deep learning operations. The system can include a system implemented using an edge device. The system can include a system implemented using a robot. The system can include a system for performing conversational AI operations. The system can include a system for generating synthetic data. The system can include a system incorporating one or more virtual machines (VMs). The system can include a system implemented at least partially in a data center. The system can include a system implemented at least partially using cloud computing resources.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having now described some illustrative implementations, the foregoing is illustrative and not limiting, having been presented by way of example. In particular, although many of the examples presented herein involve specific combinations of method acts or system elements, those acts and those elements may be combined in other was to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A’ and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

Scope of the systems and methods described herein is thus indicated by the appended claims, rather than the foregoing description. The scope of the claims includes equivalents to the meaning and scope of the appended claims.

What is claimed is:

1. A processor comprising: one or more circuits to:
allocate one or more portions of a mesh in a three-dimensional (3D) space to one or more processing units associated with the one or more circuits, the mesh associated with a surface of an object in the 3D space;
transform, using the one or more of the processing units, one or more of the portions of the mesh into corresponding second meshes in a two-dimensional (2D) space;
segment, by the one or more of the processing units and according to a determination that a distortion of at least one of the one or more portions of the mesh is below a threshold of parameterization, the at least one portion of the mesh into at least two further portions of the mesh, wherein the further portions are among the one or more portions of the mesh; and
generate, according to a determination that the distortion of the at least one portion of the mesh is at or above the threshold of parameterization, an output mesh including the one or more portions of the mesh.

2. The processor of claim 1, wherein the one or more circuits are to:
segment, using the one or more of the processing units and according to a path along one or more edges of the mesh, the mesh into the one or more portions of the mesh.

3. The processor of claim 2, wherein the one or more circuits are to:
segment the mesh according to a determination that at least one of the mesh or the object is a topological sphere that cannot be flattened.

4. The processor of claim 1, wherein the one or more circuits are to:
identify, using the one or more of the processing units, a node of the mesh; and
determine the path through the node.

5. The processor of claim 1, wherein the node is located at a position in the mesh having a curvature meeting a threshold associated with a curvature of the mesh in the 3D space.

6. The processor of claim 1, wherein the one or more circuits are to:
segment, using the one or more of the processing units and according to a determination that an overlap of at least two of the one or more of the portions of the mesh is below a second threshold of parameterization, the at least one portion of the mesh into two further portions of the mesh, the further portions among the one or more portions of the mesh.

7. The processor of claim 6, wherein the one or more circuits are to:
generate, according to a determination that the overlap of the at least two of the portions of the mesh is at or above the second threshold of parameterization, the output mesh including the one or more portions of the mesh.

8. The processor of claim 1, wherein a difference between sizes of the two further portions of the mesh meets or exceeds an equality threshold associated with a difference in size between the two further portions of the mesh.

9. The processor of claim 1, wherein the threshold of parameterization indicates that the portion of the mesh is inverted, in at least one direction, from the 3D space to the 2D space.

10. The processor of claim 1, wherein the processor is comprised in at least one of:
a system comprising one or more large language models (LLMs);
a system comprising one or more generative artificial intelligence (AI) models;
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for generating synthetic data;
a system implemented using one or more language models;
a system implemented using one or more large language models (LLMs);
a system implemented using one or more vision language models (VLMs);
a system incorporating one or more virtual machines (VMs);
a system implemented at least partially in a data center; or
a system implemented at least partially using cloud computing resources.

11. A method comprising:
allocating one or more portions of a mesh in a three-dimensional (3D) space to one or more processing units associated with the one or more circuits, the mesh associated with a surface of an object in the 3D space;
transforming, using the one or more of the processing units, one or more of the portions of the mesh from the 3D space into corresponding second meshes in a two-dimensional (2D) space;
segmenting, using the one or more of the processing units and according to a determination that a distortion of a portion of the mesh among the one or more of the portions of the mesh is below a threshold of parameterization, the portion of the mesh into two further portions of the mesh, wherein the further portions are among the one or more portions of the mesh; and
generating, according to a determination that the distortion of the portion of the mesh among the one or more of the portions of the mesh is at or above the threshold of parameterization, an output mesh including the one or more portions of the mesh.

12. The method of claim 11, further comprising:
segmenting, using the one or more of the processing units and according to a path along one or more edges of the mesh, the mesh into the one or more portions of the mesh.

13. The method of claim 12, further comprising:
segmenting the mesh according to a determination that at least one of the mesh or the object is a topological sphere that cannot be flattened.

14. The method of claim 11, further comprising:
identifying, using the one or more of the processing units, a node of the mesh; and
determining, using the one or more of the processing units, the path through the node.

15. The method of claim 11, wherein the node is located at a position in the mesh having a curvature meeting a threshold associated with a curvature of the mesh in the 3D space.

16. The method of claim 11, further comprising:
segmenting, using the one or more of the processing units, the portion of the mesh into two further portions of the mesh, the further portions among the one or more portions of the mesh.

17. The method of claim 11, further comprising:
segmenting the further portions among the one or more portions of the mesh according to a determination that an overlap of two or more of the portions of the mesh is below a second threshold of parameterization.

18. The method of claim 17, further comprising:
generate, according to a determination that the overlap of the two or more of the portions of the mesh is at or above the second threshold of parameterization, the output mesh including the one or more portions of the mesh.

19. The method of claim 17, wherein a difference between sizes of the two further portions of the mesh meets an equality threshold associated with a difference in size between the two further portions of the mesh.

20. The method of claim 11, wherein the threshold of parameterization indicates that the portion of the mesh is inverted in at least one direction, from the 3D space to the 2D space.
